(19) United States
(12) Patent Application Publication
(10) Pub. No.: US 2015/0364056 A1
(43) Pub. Date: Dec. 17, 2015

(54) VIRTUAL CLASS-BASED GLOBAL CITIZENSHIP INCUBATING SYSTEM AND METHOD

(71) Applicant: CULTURE KOREA, Seoul (KR)

(72) Inventor: Eun Ha SONG, Seoul (KR)

(21) Appl. No.: 14/377,301

(22) PCT Filed: Apr. 24, 2014
(86) PCT No.: PCT/KR2014/003582

§ 371 Date: Aug. 7, 2014

(30) Foreign Application Priority Data
Apr. 29, 2013 (KR) 10-2013-0047316

(51) Int. Cl. G09B 19/00; H04L 29/08; G09B 7/02

(52) U.S. Cl. CPC G09B 19/00; G09B 7/02; H04L 67/02

(57) ABSTRACT

Provided are a virtual class-based global citizenship incubating system and method. The system and method allow participants all over the world to perform global educational exchange among participants and instructors, among the participants, and among participant groups through a platform supporting one of a web, mobile network, social network services (SNS), cloud, and a combination thereof while overcoming a spatio-temporal limitation and include processes of matching, exchange, problem-solving, homework, evaluation, and certification.

### FIELD

The present invention relates to a virtual class-based global citizenship incubating system and method, and more particularly, to a virtual class-based global citizenship incubating system and method including a platform, which is a process of providing global exchange through education and study while overcoming limitations in time and space among worldwide participants and instructors, participants and participants, and participant groups through the platform supporting a web, mobile network, social network service (SNS), cloud, or a combination thereof, in which mutual matching, exchange, problem-solving, evaluation, and certification are performed and participants and instructors act the part in knowledge-creators based on the platform, thereby constructing archives capable of allowing education contents to be spontaneously produced and developed through a virtuous cycle of collecting, editing, recreating, evaluating, sharing, or a combination thereof and selectively providing education materials having good quality adapted to education objects and requirements of participants through the archives.

### BACKGROUND

Incubating indicates increasing and culturing something. Accordingly, incubating global citizenship means preparing and culturing citizenship or basic qualities of global citizens for cultivating global talented people capable of actively performing exchange worldwide.

Recently, as exchange among nations of the world becomes active, the globalization of values and educational information and the globalization of social capital and human capital have been performed. Globally, practical abilities of working in international community, such as understanding of multi cultures and communicative competence, are necessary.

According to this, there is an overseas exchange study program, one of general representative international exchange studies. However, a large amount of cost and time are consumed to digest this program. Also, students participating in the overseas exchange study program have failed to adapt to local areas due to lingual or cultural differences or sudden environmental changes or frequently have felt lost and have deviated while being separate from parents thereof.

Recently, according to development of technology, online educations using international video calls and videos have been introduced. However, these educations have limitations such as low immersion and a decrease in participation of participants or learners.

Accordingly, there is a limitation in teaching through an available way of communicating with global community using worldwide networks in general learning systems. Also, the learning systems lack allowing learners to find chances of new learning through cooperative projects with people all over the world and to grow up as global citizens through meaningful international exchange activities.

### DETAILED DESCRIPTION

### Technical Problem

The present invention provides a virtual class-based global citizenship incubating system and method capable of constructing a system for supporting a virtual class using a platform supporting a worldwide web, mobile network, social network services, cloud, and a combination thereof to allow participants to spontaneously have learning motivation and objective through interactions with people around the world and to actively and continuously take part in international exchange activities through education and learning. The present invention also provides a virtual class-based global citizenship incubating system and method capable of allowing participants or learner to build up global literacy and to extend a worldwide network for personal connections to act as global citizens through group matching between participants or learners, interactions with colleagues, interactions with instructors, problem-solving, cooperation project, and an evaluation and certification process.

### Technical Solution

According to an aspect of the present invention, there is provided a virtual class-based global citizenship incubating system including a global citizenship incubating platform server supporting one of a web, mobile network, social network services, cloud, and a combination thereof and providing services of a plurality of virtual classes and a storage unit including a virtual class database. Herein the platform server provides and manages one of learning and education process including a learning process of performing flipped learning, a learning process of performing a global cooperative competitive project, and a combination thereof, and the platform server supports to configure a variable tenant, which is a group of participants taking part in the virtual class, to provide global exchange through one of learning and education among participants all over the world and instructors, among the participants, or among groups of the participants. The virtual class database may include learning databases for nations and themes, respectively. The storage unit may further include one of a preliminary learning database, an online debate database, a cooperative learning database, an evaluation database, a certification database, and a combination thereof. The cooperative learning database may include a 1:1 exchange learning database and a team project database. The platform server may be connected to at least one learning terminal as a three-tier server client model and prevents the learning terminal from directly accessing the storage unit. The platform server may provide international exchange education and learning to the at least one learning terminal through N-screen services. The platform server may be formed as a distributed server distributed into a server for matching the participants, learners, and groups, a server for exchange among colleagues and instructors, a server for solving problems, a server for cooperative projects, a server for evaluation, a server for certification, and a combination thereof. The platform server may be formed as a parallel-distributed server, in which a plurality of the distributed servers are connected in parallel. The platform server may support construction of archives allowing educational contents to be spontaneously produced and to develop through one of collecting, reediting, recreating, sharing evaluation of learning materials scattering in the whole world, and a combination thereof, performed by the participants and instructors, and selectively provides participation materials customized to targets and requirements of learning of the participants through the archives. The platform server may provide a hypertext mark-up language (HTML) 5-based web application to allow a web application for international exchange learning to be executed regardless of specifications of the learning terminal.

According to another aspect of the present invention, there is provided a virtual class-based global citizenship incubating method including receiving membership information from participants all over the world, inputted to a global citizenship incubating platform server 200 supporting one of a web, mobile network, SNS, cloud, and a combination thereof, automatically searching a virtual class related to participant information and an interesting field inputted for entry and recommending the virtual class to the participant, supporting the participant to register and access a desired virtual class to join, providing and managing a learning course performing flipped learning in the virtual class, and providing and managing a learning course performing a global cooperative competitive project in the virtual class. The method may further include providing a result list when a search for various virtual classes and projects present in the platform server 200 is performed. The method may further include supporting, by the platform server 200, an instructor being in charge of the virtual class to register contents available for preliminary learning to perform the flipped learning in the virtual class. The method may further include supporting the participant to perform debate with related contents as a theme with the instructor and other participants of the virtual class and providing interactive feedback after the participant finishes the preliminary learning. The method may further include registering results of performing the project in a storage unit and evaluating the results, certifying expertise of the participant according a result of the evaluation, and issuing a certificate for the certified participant.

### Advantageous Effects

According to the embodiment, a participant may have global citizenship having global literacy ability required to global citizens in 21st century, such as solving-problem on international issues, multicultural communication, leadership, teamwork, creative-convergent thought, analytic thought, sympathy, and consideration and may learn to be able to perform a role of practical international exchange through interactions with peoples in various countries using a virtual system employing a platform supporting one of a web, mobile network, SNS, cloud, and a combination thereof connecting the whole world. Also, a personal connection network may be connected worldwide and extended while overcoming a spatio-temporal limitation among participants and instructors, among participants and participants, or among participant groups by matching participants and instructors accessing the virtual system.

### BRIEF DESCRIPTION OF THE DRAWINGS

To fully understand the drawings referred in a detailed description, a brief description of the respective drawings will be provided as follows:

FIG. 1A is a configuration view of a virtual class-based global citizenship incubating system according to an embodiment of the present invention;

FIG. 1B is a configuration view of a server including a virtual class-based global citizenship incubating platform according to an embodiment of the present invention;

FIG. 2 is a configuration view of the virtual class-based global citizenship incubating system having a parallel-distributed structure according to an embodiment of the present invention;

FIG. 3 is a detailed configuration view of a database of the virtual class-based global citizenship incubating system of FIG. 2;

FIG. 4 is a configuration view of local, global, and thematic learning databases of a virtual class database shown in FIG. 3;

FIG. 5 is a flowchart illustrating a method of providing international exchange learning through a virtual system according to an embodiment of the present invention; and;

FIG. 6 is a view illustrating effects obtainable through the global citizenship incubating system and method using the virtual system according to the embodiment of the present invention.

### MODE FOR CARRYING OUT THE INVENTION

A virtual class-based global citizenship incubating system according to an embodiment of the present invention provides superlative means for allowing participants joining global citizenship incubating services to incubate global citizenship by providing the participants with web-based mobile cloud computing platforms and social network services (SNS) at the same time. Accordingly, the system allows the global citizen ship to be incubated through one of a platform of a web, mobile network, SNS, clouds, and a combination thereof. Participants from all over the world joining the platform take part in education and learning through a virtual class. The participants taking part in the virtual class are grouped as a variable tenant for each virtual class. Each participant of the tenant is preliminarily provided with a chance of global citizenship education and learning through international exchange with adjacent participants belonging to the same tenant. That is, the tenant designates a group of participants taking part in the virtual class. The participants may freely generate and configure the virtual class, thereby taking part in more various global citizenship incubating services. At that time, a new tenant is generated and then it is possible to internationally exchange with other participants belonging the tenant. Activities described above are maintained, thereby allowing the participants to naturally interact with peoples from all over the world. From this, an effect of incubating the global citizenship becomes revealed.

Hereinafter, the virtual class-based global citizenship incubating system and method according to the embodiment will be described with reference to the attached drawings.

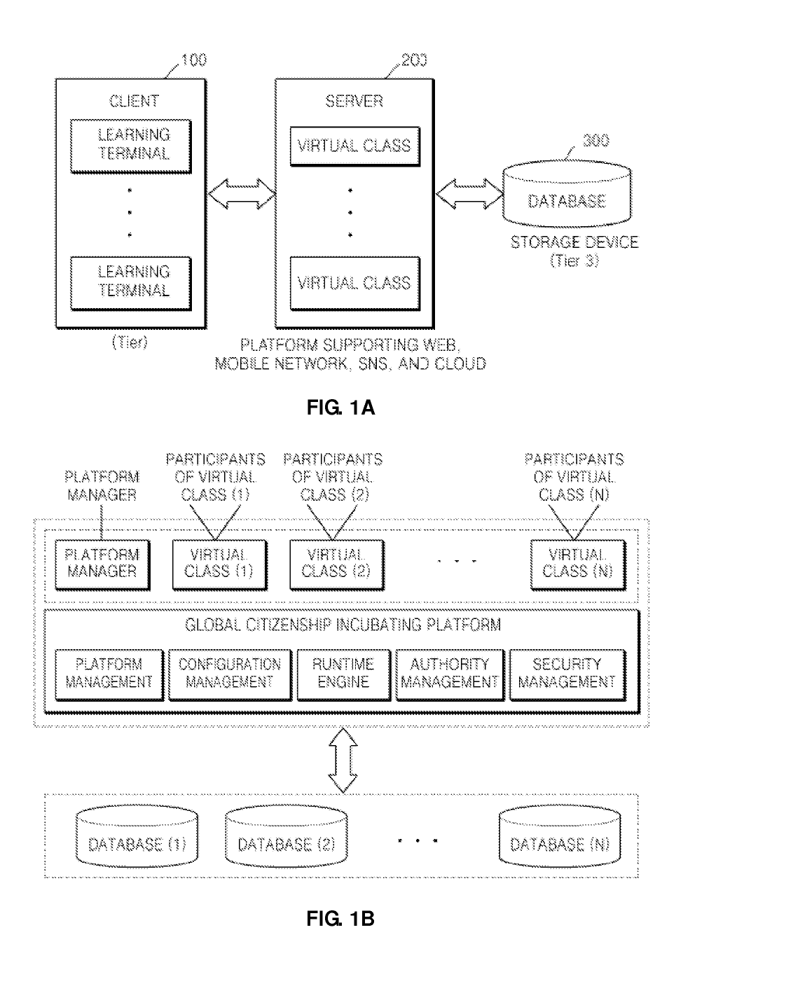

FIG. 1A is a configuration view of the virtual class-based global citizenship incubating system. The system includes a learning terminal 100 accessed by international exchange participants, a server 200 managing a website including a virtual class accessed by each learning terminal 100 and supporting to perform a learning process, and a storage unit 300 classifying and registering results of learning and projects to be referred.

The learning terminal 100 is used by a participant who would like to join in the virtual class and indicates the entire of client terminals including a wired or wireless online-accessible computer, mobile terminal, tablet personal computer, or smart-phone. As described above, participants, who would like to join in the virtual class, gather to form a tenant and the tenant may be variable according to a selection of the participants.

The sever 200 allows participants from all over the world to access the virtual international exchange learning website using the learning terminal 100. According to a request of the participant, the learning terminal 100 executes a search for various virtual classes and projects existing in a website of the server 200 and shows a list of results. In the embodiment, the server 200 may be configured to include a platform supporting a web, mobile network, SNS, cloud, or a combination thereof, thereby providing virtual class services through a mobile cloud using web-based SNS. In addition, through the mobile cloud, N-screen services through handover between heterogeneous learning terminals may be supported. In other words, a participant, that is, a learner being provided with education and learning through a smart phone may be provided with the N-screen services while executing handover by separating video streams from audio streams through a terminal providing low or high sound and image qualities according to location. Particularly, when image quality or sound quality are low, services changed over through a device providing higher image quality or sound quality may be immediately provided in real time.

The storage unit 300 may classify and store information on a curriculum such as education information, learning material, learning outcome, and evaluation results in separate databases 301 to 360. Herein, the storage unit 300 or database may be at least one of a storage unit directly connected to the server, a storage unit of an additionally configured data server, and a storage unit of a cloud system connected through a network.

FIG. 1B is a configuration view of a server including a virtual class-based global citizenship incubating platform according to an embodiment of the present invention. The server may be configured to include N number of virtual classes, a platform management user interface (UI), and the global citizenship incubating platform. Each of a plurality of virtual classes is generated provide each participant with exclusive global citizenship incubating services, thereby allowing participants joining various classes to gather together and to take part in education through cooperation.

The platform may be configured including modules performing platform management, component management, runtime engine, authority management, and security management. A platform manager may manage the platform through the platform management UI. Material generated through the platform may be stored and managed in the database under the control of the platform.

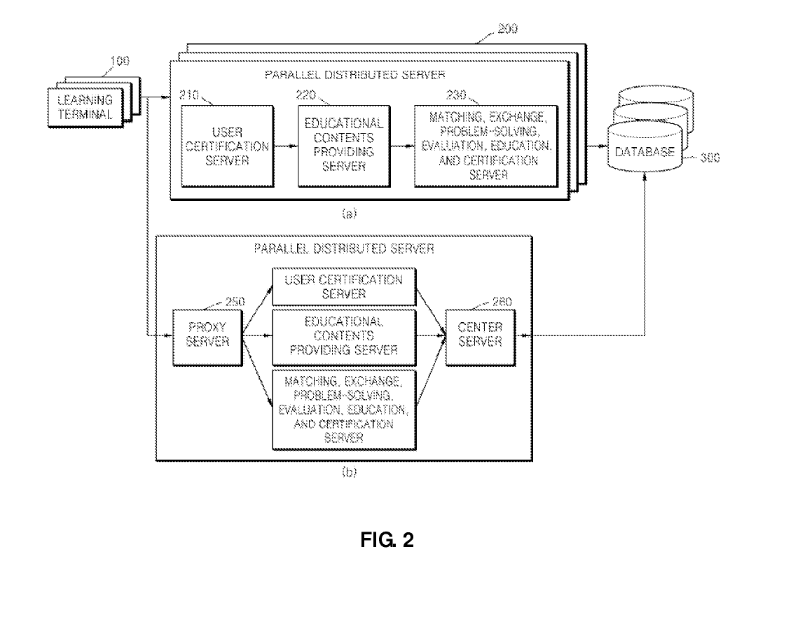

As known from FIG. 1B, since virtual classes continuously increases as the number of participants gradually increases, it will be impossible to provide smooth services through a virtual class-based global citizenship incubating system including only one server and database storage unit. That is, when the number of participants increases, the server and database may lack capacities or a bottleneck phenomenon may occur in a network. Accordingly, according to the embodiment, there is provided a parallel-distribution system as shown in FIG. 2.

FIG. 2 is a configuration view of the virtual class-based global citizenship incubating system configured to have a parallel-distributed structure according to an embodiment of the present invention. The system includes a plurality of learning terminals, that is, clients 100, a parallel-distributed server 200 supporting to perform a curriculum including virtual classes accessed by the plurality of learning terminals, respectively, and a storage unit 300 such as a database for classifying, storing, and registering various participation materials and project outcomes to be searchable for each category.

In FIG. 2, the learning terminal 100 may function as a client or an agent and is provided with virtual class-based global citizenship incubating services by accessing the server through a wired or wireless communication network. Also, the server 200 is installed with characteristic function thereof and management function and includes a platform allowing global exchange between participants from all over the world and an instructor, between participants, or between participant groups through education and learning exceeding a spatiotemporal limit through networks such as a web, mobile network, SNS, cloud, etc. In addition, the storage unit 300, as a database, may be at least one of a storage unit directly connected to the server, a storage unit of an additionally configured data server, and a storage unit of a cloud system connected through a network.

That is, the virtual class-based global citizenship incubating system may be formed of a 3-tier client-server model. Herein, the client 100 allows a user to actually access the server 200 and to receive or directly take part in education. Also, online education stores data used in the education in the database 300 and uses the data. The configuration described above allocates data handling to the database 300 and cuts off a direct access of the client 100 to the database 300, thereby properly processing education data by the server 200. When the client 100 tries to register material in the database 300, it is controlled only to allow a user certificated by the platform of the server 200 to register material in the database 300.

In this structure, an increase in the participants taking part in education causes an increase in the clients 100 accessing the server 200 and executing education. To effectively executing the education, it is necessary to distribute the functions of the server 200 to a plurality of servers.

The server 200 may be configured to include a mobile cloud platform. In this case, a mobile terminal such as a cellular phone is provided with an execution environment allowing the user to use education applications or services. Mobile platforms are largely classified into terminal platforms and server platforms. The terminal platform indicates a platform loaded in a terminal such as an operation system middleware browser, and the server platform indicates a platform loaded in a server such as a server level such as certification and charging, gateway, an online market place. From the point of view of a user including a participant, an instructor, or a manager, a terminal platform loaded in a learning terminal is a mobile platform. The user may be provided with more realistic educational contents through the terminal platform. Since cloud computing allows a user only to execute various programs through a terminal only simply accessible to a network while all executable programs and hardware are being connected to a cloud through a network, outcome of being educated and contents of education participation are stored in a web in such a way that the user always may access information thereof through a network function of a terminal held by the user every time and every where.

The cloud computing, user-centric, may always be used, which is an array of conveniently available educational and computing resources. A high-capacity database may be distributed into an Internet virtual space through a web-based application, and data thereof may be fetched or processed by various terminals such as a personal computer (PC), a cellular phone, a laptop PC, a smart phone, and personal digital assistants (PDA). To provide realistic educational contents through various learning terminals described above, data backup, printing, and N-screen services may be provided.

In addition, to allow a web application to be independent from the specifications of a terminal such as an operation system and a platform to be executable in any terminal, an HTML5-based web application may be provided. HTML5 not only strengthens expressions of meaning by adding new markups but also improves an interaction with a user such as a UI and includes considerably many functions such as effective real-time communication function based on hypertext transfer protocol (HTTP), web-applied offline support function, and device location access function.

The learning terminal is installed with an app, that is, an application program, thereby executing international exchange learning. Through the app, it is possible to back up learning material stored in the database, to manage a version, or to synchronize with a cloud storage device. In addition, with respect to the printing, print formats corresponding to various printer types may be provided through the app.

The virtual class-based global citizenship incubating system provides N-screen services regardless of the resolution of a screen of a learning terminal accessing a server platform, in which the platform stores resolution information according to various learning terminals and recognizes that of a random learning terminal accessing the platform to stream contents optimized for a corresponding resolution.

In FIG. 2, in the distributing of the global citizenship incubating server to use a plurality of servers, it is necessary to maintain high extendibility and efficiency while considering properties of the system. Accordingly, detailed functions appropriate for a basic structure of the global citizenship incubating server and properties of global education are determined. Then, according to development of educational contents and an increase in users, both flexibility and extendibility are allowed to be provided at the same time and also maintenance of stability and smooth support for the detailed functions of education are allowed to be provided. According thereto, the global citizenship incubating server may be allowed to perform basic distributed-processing and also may greatly improve a processing capacity of an educational server through data parallelization.

Distribution according to the structure of the global citizenship incubating server is to separate the global citizenship incubating server into distributed servers capable of independently performing functions thereof. The separation of the distributed servers may be provided by separating the functions according to a function to be executed by each distributed server, a processing stage and a processing function, and a processing tier.

FIG. 2(a) is a configuration diagram of a parallel-processing distributed server through separating a server according to the processing stage, and FIG. 2(b) is a configuration diagram of a parallel-processing distributed server through separating a server according to the processing function and the processing tier.

In more detail, in the separation of the distributed servers according to the processing stage, when a large number of participants throughout the world and an instructor access in one space or access a waiting room collected with the participants, the functions of the educational server are distributed according to the status of users such as user certification and participation in education. That is, an education-participant accesses a platform of the server through a learning terminal and it is necessary to receive user certification from a user certification server 210 first. After that, the participant is provided with educational contents according to a virtual class through an educational contents providing server 220 and takes part in the class and performs activities through mutual cooperation among participants to match, exchange, and solve a problem through matching, exchange, program-solving, evaluation, education-certification servers while taking part in global citizenship incubating. A participant completing a curriculum of the virtual class receives education certification through an evaluation and will henceforward strengthen global citizenship through international exchange with participants in the same class or in other classes. Accordingly, the matching, exchange, problem-solving, evaluation, and education certification servers may be separated to be configure a matching, exchange, and problem-solving server and an evaluation and education certification server. Accordingly, in FIG. 2(a), the configuration of the server for incubating global citizenship based on the virtual class may be allowed to distribute and process functions of the server for each stages of providing services in parallel.

FIG. 2(b) illustrates the configuration of the parallel-processing distributed server through the separation of the server according to the processing function and the processing tier. The separation of the distributed servers according to the processing function allows the educational server distributed and defined according to the processing stage to increase efficiency and extendibility of processing a request of a client. The educational server distributed according to the processing function configures a tier for connection or management of the educational server or adds a tier for being exclusively responsible for function. That is, a center server managing and connecting the distributed server and a proxy server relaying a client and the distributed server to separate internal/external networks from each other and to continuously use initial connection may be added.

In the embodiment, the separation of the servers according to the processing stage and the processing function and the processing tier may be performed by separating servers according to a learning stage, a learning function, or a learning tier appropriately for the scale of participants and a personality of each participant, thereby configuring the parallel-distributed-processing system. Also, the parallel-distributed processing structure performs participant and group matching, exchange among colleagues and instructors, problem-solving, cooperation projects, evaluation, and certification based on the system including the platform supporting web, mobile network, SNS, cloud, or a combination thereof. During this process, global exchange between participants from all over the world and an instructor, between the participants, or between participant groups, is allowed to be provided through education and learning overcoming a spatiotemporal limit via a network such as web, mobile network, SNS, cloud, etc.

The separation according to the processing stage, processing function, and processing tier of education and learning shown in FIG. 2 is to separate a processing stage, processing function, and processing tier of a distributed server according to learning of a client. The separation may configure the parallel-distributed processing system by separating the processing stage, processing function, or processing tier into the server for performing participant and group matching, exchange between participants and instructors, problem-solving, cooperation projects, evaluation, and certification between worldwide participants and an instructor, between the participants, or between participant groups overcoming the spatiotemporal limit.

The distribution according to function may more increase processing capacity of distributed processing by configuring parallel processing. Particularly, since a capacity may be continuously improved through parallel processing although a load continuously increases according to the number of users, there is provided a greater effect.

When there is a difficulty to configure parallel processing as described above, the extendibility of the educational server is increased by dividing educational data to be processed. To allow an online educational server to have high extendibility, distributed-processing with respect to a server increasing in a load as an increase of users is to be supported.

Also, it is possible to integrate and manage physically heterogeneous storage devices into one logically virtualized storage pool through storage virtualization. A storage virtualization skill may increase a utilization rate of storage resources, thereby reducing costs thereof.

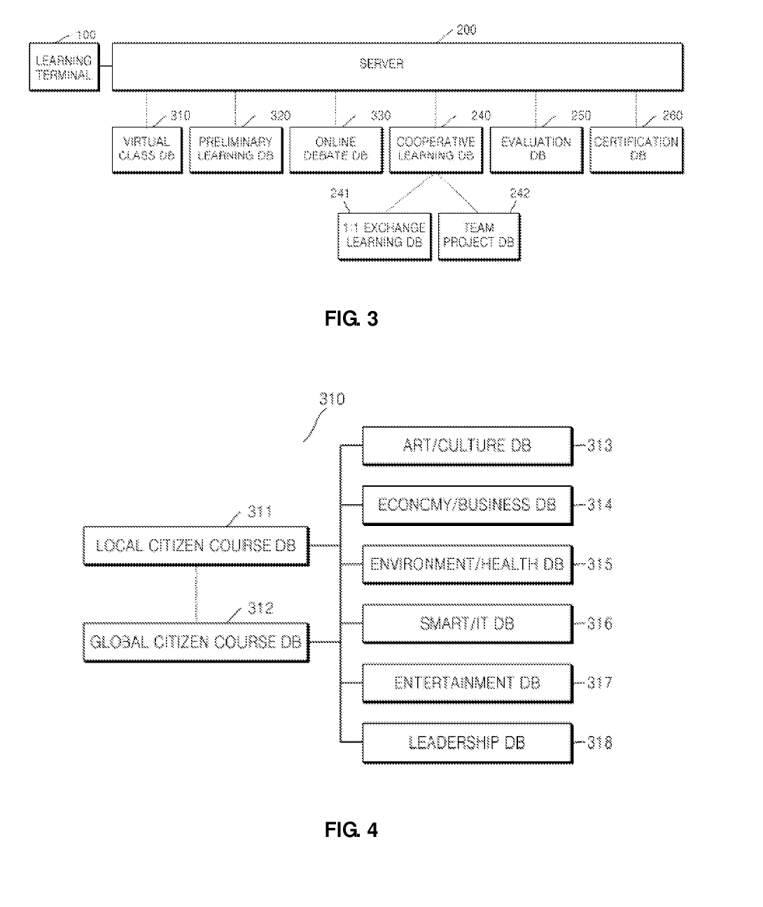

FIG. 3 is a detailed configuration view of the database of the virtual class-based global citizenship incubating system. The system includes the learning terminal 100, the sever 200, and the database 300. In detail, the database 300 includes a virtual class database 310, a pre-learning database 320, an online debate database 330, a cooperation learning database 340 including a 1:1 exchange learning database 341 and a team project database 342, an evaluation database 350, a certification database 360, or a combination thereof.

The components shown in FIG. 3 may correspond to the learning terminal 100, the educational server platform 200, and the database 300, respectively, as a storage unit, which are connected to one another through mutual wired and wireless networks. Particularly, as the number of participants increases, the database 300 may integrate and manage two physically different storage devices into one logically virtualized storage pool by using storage virtualization technology to make better use of storage resources, thereby reducing costs thereof.

FIG. 4 is a configuration view of local, global, and thematic learning databases of the virtual class database shown in FIG. 3. The virtual class database 310 stores learning information of virtual classes offered for each nation and theme and includes a local citizen course database 311 providing pieces of leaning information having a theme of a certain nation and a region and a global citizen course database 312 providing pieces of learning information having a theme of common international issue. Herein, information in the local citizen course database 311 and thee global citizen course database 312 may be classified into sub themes and stored in an art/culture database 313, a economy/business database 314, an environment/health database 315, a smart/information technology (IT) database 316, an entertainment database 317, a leadership database 318, and a combination thereof. Herein, one or more of courses may be replaced by another new course.

On the other hand, the virtual class, which is a learning space of participants and instructors, is offered through the server 200 and information on the participants and instructors and learning material are recorded and posted.

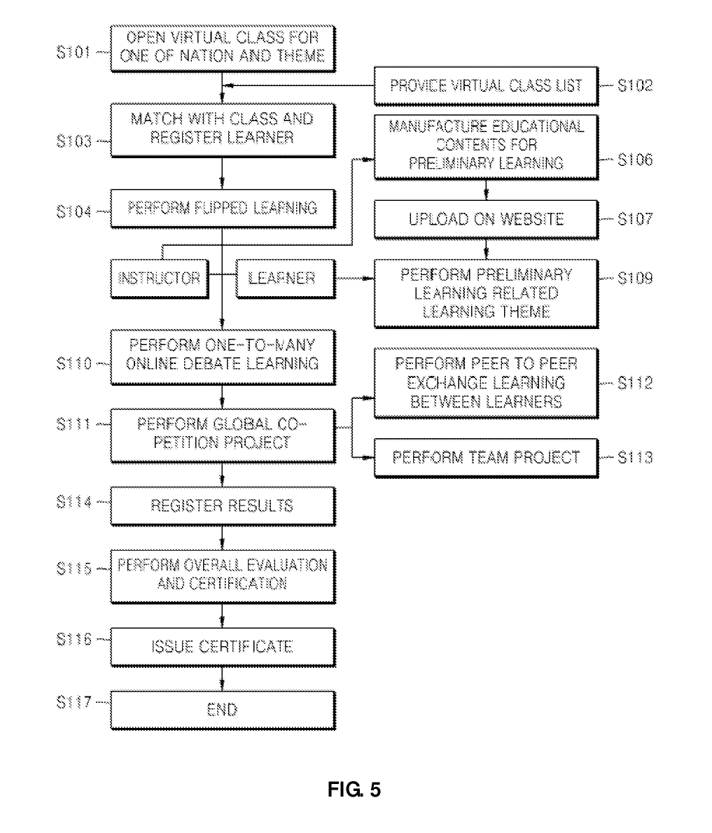

FIG. 5 is a flowchart illustrating a method of providing international exchange learning through the virtual system according to an embodiment of the present invention. A participant is provided with a customized virtual class for each nation or theme and a project list according to personal information, an interesting nation, theme information, registered in the server 200 (S101) or is provided with a desired virtual class list through direct search (S102). The participant selectively registers a desired class and then starts learning together with other global participants having common interests (S103).

After that, flipped learning is performed (S104), which will be described as follows.

The flipped learning is a new learning method introduced to worldwide classes according to the development of new technology. Herein, flipping designates overturning. A general traditional class is performing tasks. However, in the flipped learning, a lecture is homework and class is filled with doing exercises. For example, a teacher makes a video with running time of from about 8 to about 10 minutes through a laptop thereof or records his or her voices and takes a picture of a note on a whiteboard to explain educational concepts. Also, the teacher may upload the video, note or voice on a website of school or youtube to allow learners to access them using a personal computer or a smart phone. The class is entirely provided to do exercises to allow the contents thereof to be applied, thereby allowing learners to more actively and aggressively take part in the class.

An example of applying the flipped learning system to a virtual international exchange learning course will be described as follows. The instructor accesses a website, manufactures educational contents allowing learning contents to be understood (S106) and uploads the educational contents on the website (S107). The participant performs preliminary learning through a learning terminal thereof (S109). Herein, the contents may have various forms such as animation, power point presentation, streaming audio and video, and web browser. Also, questions and answers may be performed through a bulletin board of the website, community, and SNS. Online debate learning performed after the preliminary learning is performed through a wired or wireless communication system including a messenger, an e-mail, voice calls, video calls, or a combination thereof, in which opinions of participants, and further learning information related to the theme of learning are given and taken (S110).

Next, a global cooperation project is performed, which will be described as follows.

That is, the learners may make thought and vision thereof clear while finding identity thereof in a network connected with colleagues and giving and taking various opinions among them and cooperating with them. Also, the learners may obtain strong energy called motivation through interaction through social networks. Additionally, co-petition learning helps participants being passionate creator themselves. A chance of doing a significant task together with cooperative people is provided to allow participants to share work thereof and to help one another, thereby having a positive effect on a growth process.

An example of applying the global co-petition learning system to the virtual international exchange learning course will be described as follows (S111). Participants living in different regions are matched as a pair or multiple and execute exchange learning with a theme related to mutual nations or regions. Participants select a theme for each nation, region, category, to which they belong, collect and reedit learning materials having an open-source scattered online to form a curriculum, and upload the learning materials on the virtual class server to mutually exchange and share knowledge. Herein, not participants are allowed not only to unilaterally watch materials provided by colleagues but also to be provided with a forum of participation and exchange using a real-time debate and chat room. In addition, learning contents are shared through an SNS system, thereby extending the experience of learning While sharing knowledge and information with colleagues in other countries, not only foreign language ability but also a planning ability of configuring a curriculum, story-telling ability, persuasiveness, cultural magnanimity, and powers of communication and presentation may be cultivated (S112). A team project, which is another co-petition learning course, is a process, in which participants exchange opinions thereof, listen to lectures, or share materials through the virtual class system to solve a project on the same theme related to a regional and international issue between participants (S113). Accordingly, an output of the team project is registered in a virtual space to share with other participant (S114). The registered output is finally evaluated including a system of evaluation and recommendation of other participants. Evaluation criteria include a will and ability to solve the problem related to an international issue, multicultural communication, leadership, teamwork, creative-convergent thought, analytic thought, sympathy, and consideration (S115). A result of the evaluation is stored in the certification database and it is determined whether certification is performed. Additionally, a certificate of appointment of an international exchange expert for a certain nation and theme is issued online and given to a final successful applicant (S116).

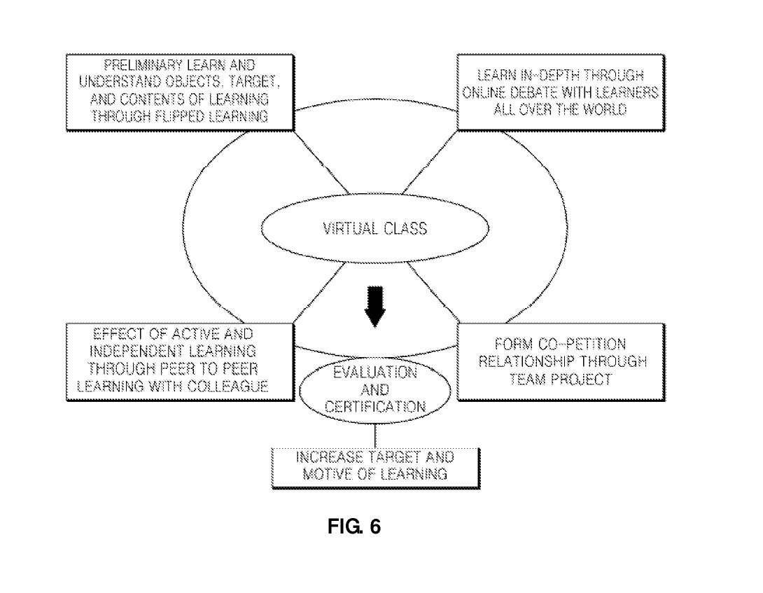

FIG. 6 is a view illustrating effects obtainable through the global citizenship incubating system and method using the virtual system according to the embodiment. According to the embodiment, a participant may have global citizenship having global literacy ability required to global citizens in 21st century, such as solving-problem on international issues, multicultural communication, leadership, teamwork, creative-convergent thought, analytic thought, sympathy, and consideration and may learn to be able to perform a role of practical international exchange through interactions with peoples in various countries using a virtual system employing a platform supporting one of a web, mobile network, SNS, cloud, and a combination thereof connecting the whole world. Also, a personal connection network may be connected worldwide and extended while overcoming a spatio-temporal limitation among participants and instructors, among participants and participants, or among participant groups by matching participants and instructors accessing the virtual system.

In more detail, the virtual class-based global citizenship incubating system and method may allow participants 1) to preliminarily learn and understand objects, targets, and contents of learning through flipped learn, 2) to perform in-depth learning through online debate with participants from all over the world, 3) to obtain active and independent learning effects through 1:1 learning with a colleague, and 4) to form co-petition relationship through team project. According to the process, participants are allowed to be learned through a virtual class. Also, it to be checked through an evaluation and certification process related to an output of the learning whether a learning object is achieved.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

The present invention may be applied to an industrial field of virtual class-based global citizenship incubating.

1. A virtual class-based global citizenship incubating system comprising:
a global citizenship incubating platform server supporting one of a web, mobile network, social network services, cloud, and a combination thereof and providing services of a plurality of virtual classes; and
a storage unit including a virtual class database,
wherein the platform server provides and manages one of learning and education process comprising a learning process of performing flipped learning, a learning process of performing a global co-petition project, and a combination thereof, and
wherein the platform server supports to configure a variable tenant, which is a group of participants taking part in the virtual class, to provide global exchange through one of learning and education among participants all over the world and instructors, among the participants, or among groups of the participants.

2. The system of claim 1, wherein the virtual class database comprises learning databases for nations and themes, respectively.

3. The system of claim 1, wherein the storage unit further comprises one of a preliminary learning database, an online debate database, a cooperative learning database, an evaluation database, a certification database, and a combination thereof.

4. The system of claim 3, wherein the cooperative learning database comprises a 1:1 exchange learning database and a team project database.

5. The system of claim 1, wherein the platform server is connected to at least one learning terminal as a three-tier server client model and prevents the learning terminal from directly accessing the storage unit.

6. The system of claim 1, wherein the platform server provides international exchange education and learning to the at least one learning terminal through N-screen services.

7. The system of claim 1, wherein the platform server is formed as a distributed server distributed into a server for matching the participants, learners, and groups, a server for exchange among colleagues and instructors, a server for solving problems, a server for cooperative projects, a server for evaluation, a server for certification, and a combination thereof.

8. The system of claim 7, wherein the platform server is formed as a parallel-distributed server, in which a plurality of the distributed servers are connected in parallel.

9. The system of claim 1, wherein the platform server supports construction of archives allowing educational contents to be spontaneously produced and to develop through one of collecting, reediting, recreating, sharing evaluation of learning materials scattering in the whole world, and a combination thereof, performed by the participants and instructors, and selectively provides participation materials customized to targets and requirements of learning of the participants through the archives.

10. The system of claim 1, wherein the platform server provides a hypertext mark-up language (HTML)5-based web application to allow a web application for international exchange learning to be executed regardless of specifications of the learning terminal.

11. A virtual class-based global citizenship incubating method comprising:
receiving membership information from participants all over the world, inputted to a global citizenship incubating platform server supporting one of a web, mobile network, SNS, cloud, and a combination thereof;
automatically searching a virtual class related to participant information and an interesting field inputted for entry and recommending the virtual class to the participant;
supporting the participant to register and access a desired virtual class to join;
providing and managing a learning course performing flipped learning in the virtual class; and
providing and managing a learning course performing a global co-petition project in the virtual class.

12. The method of claim 11, further comprising providing a result list when a search for various virtual classes and projects present in the platform server is performed.

13. The method of claim 11, further comprising supporting, by the platform server, an instructor being in charge of the virtual class to register contents available for preliminary learning to perform the flipped learning in the virtual class.

14. The method of claim 13, further comprising supporting the participant to perform debate with related contents as a theme with the instructor and other participants of the virtual class and providing interactive feedback after the participant finishes the preliminary learning.

15. The method of claim 11, further comprising:
registering results of performing the project in a storage unit and evaluating the results;
certifying expertise of the participant according a result of the evaluation; and
issuing a certificate for the certified participant.
